(19) United States
(12) Patent Application Publication
(10) Pub. No.: US 2019/0333104 A1
(43) Pub. Date: Oct. 31, 2019

(54) Systems and Methods for Use in Controlling Network Activities

(71) Applicant: MASTERCARD INTERNATIONAL INCORPORATED, PURCHASE, NY (US)

(72) Inventors: Christopher Eric Mullen, St. Peters, MO (US); Juan Edward Black, St. Charles, MO (US); Brian Williams, St. Peters, MO (US)

(21) Appl. No.: 15/963,982

(22) Filed: Apr. 26, 2018

(51) Int. Cl. G06Q 30/02

(52) U.S. Cl. CPC G06Q 30/0251; G06Q 30/0273

(57) ABSTRACT

Systems and methods are provided for controlling categories of users based on network activity associated with the users at web browsers. One exemplary method includes transmitting, by a user feedback server (UFS), a web site to a user at a communication device and soliciting a feedback input associated with a prior network activity of the user. The UFS receives the feedback input from the user for a network object. The feedback input includes a unique identifier (ID) and a network object identifier associated with the network object. The unique ID is associated with at least one of the user and the communication device. The UFS transmits the feedback input (or portion thereof) to a host, whereby the host is permitted, based on the unique ID and the network object identifier, to adjust inclusion of the user and/or the communication device in one or more categories of users and/or communication devices.

### FIELD

The present disclosure is generally directed to systems and methods for use in controlling network activities, and in particular, to systems and methods for use in controlling content directed to computing devices via networks.

### BACKGROUND

This section provides background information related to the present disclosure which is not necessarily prior art.

Users are known to access different web sites on the Internet, via web browsers, to view products, such as goods and services that the users intend or want to purchase. For example, a user who intends to purchase a travel product may browse through different options for hotel accommodations and/or flights at a travel merchant web site. When the user does so, the web browser in which the web site is viewed generates a cookie for the user and the web site. The cookie, which is data, is stored by the web browser and is used, at least in part, by the web site for purposes of retargeting the user when the user views the same web site or different web sites, depending on how the web sites are configured.

A Data Management Platform, or a DMP, is used to import, store and analyze data (e.g., cookie data), whereby the data may be used to target advertisements to users (e.g., in a digital advertising campaign for the travel merchant web site, etc.). A Demand-Side Platform, or DSP, receives data from the DMP and facilitates the purchase of advertising on web sites, such as a news web site, by other parties, such as the travel merchant, etc. The purchase of advertising facilitated by the DSP may include, among other things, the purchase of retargeting advertising. So, for example, where a user has browsed the travel merchant web site for a hotel in Florida and later visits the news web site, the DMP may identify the user, through the cookie, as having browsed for the hotel in Florida on the travel merchant web site, and the DSP, then, may facilitate the purchase of ad space on the news web site by third parties, such as the travel merchant, whereby the travel merchant may purchase an ad(s) for the hotel in Florida (or a related product (e.g., another hotel in Florida, etc.)) to display to the user on the news web site, so as to retarget the user.

### DRAWINGS

The drawings described herein are for illustrative purposes only of selected embodiments and not all possible implementations, and are not intended to limit the scope of the present disclosure.

FIG. 1 is an exemplary system of the present disclosure suitable for use in controlling network activity associated with web browsers and categories of users based on the network activity associated with the users at the web browsers;

FIG. 2 is a block diagram of a computing device that may be used in the exemplary system of FIG. 1; and

FIG. 3 includes a flow diagram for an exemplary method, which may be implemented in connection with the system of FIG. 1 for controlling network activity associated with a web browser and a category of a user based on network activity associated with the user at the web browser.

Corresponding reference numerals indicate corresponding parts throughout the several views of the drawings.

### DETAILED DESCRIPTION

Exemplary embodiments will now be described more fully with reference to the accompanying drawings. The description and specific examples included herein are intended for purposes of illustration only and are not intended to limit the scope of the present disclosure.

When users access merchant web sites (or other product web sites), and cookies are generated based on the products viewed on the merchant web sites (where the products viewed are, broadly, network objects), merchants rely on the cookies, via, for example, a DMP and a DSP, to purchase advertising to retarget the users for the products that have already been viewed by the users and/or other products related to the products that have been viewed by the users. An issue, however, is that when a user purchases a product previously viewed at a merchant web site or another product such that the user is no longer interested in the previously viewed product (when revisiting the web site, at a different web site, at a brick-and-mortar store, or elsewhere), there is no feedback loop which reveals the purchase to the DMP and/or DSP, whereby the user will still continue to receive retargeting advertising even after purchasing a product.

Uniquely, the systems and methods herein permit users to provide interest designations or indications (or indicators) related to cookies, whereby retargeting of the users associated with the cookies is eliminated or limited. In particular, a user feedback server (UFS) is provided in association with data analysis (e.g., of cookie data, etc.) and/or retargeting advertising. The UFS is accessible to the user, for example, via a web site. When the user accesses the UFS web site, the user is permitted to provide and submit an interest designation, which indicates the user is not interested in a product or type of product (e.g., where the user has already purchased the product or a similar type of product or otherwise lost interest, or never actually had interest, etc.). The UFS then provides, or makes available, the interest designation to the data analysis and/or retargeting advertising, whereby the user is removed and/or excluded, for example, from a list(s) of users to be targeted for the product. In this manner, the user is able to avoid receiving advertising for a product(s) in which the user has little or no interest. Further, the web host and/or merchant responsible for purchasing advertising for the product is able to avoid expending resources to advertise the product to the user with little or no interest in the product. As such, for example, the web host and/or web site displaying advertising may then avoid devoting advertising space for the display of advertising for products to users with little or interest in the products.

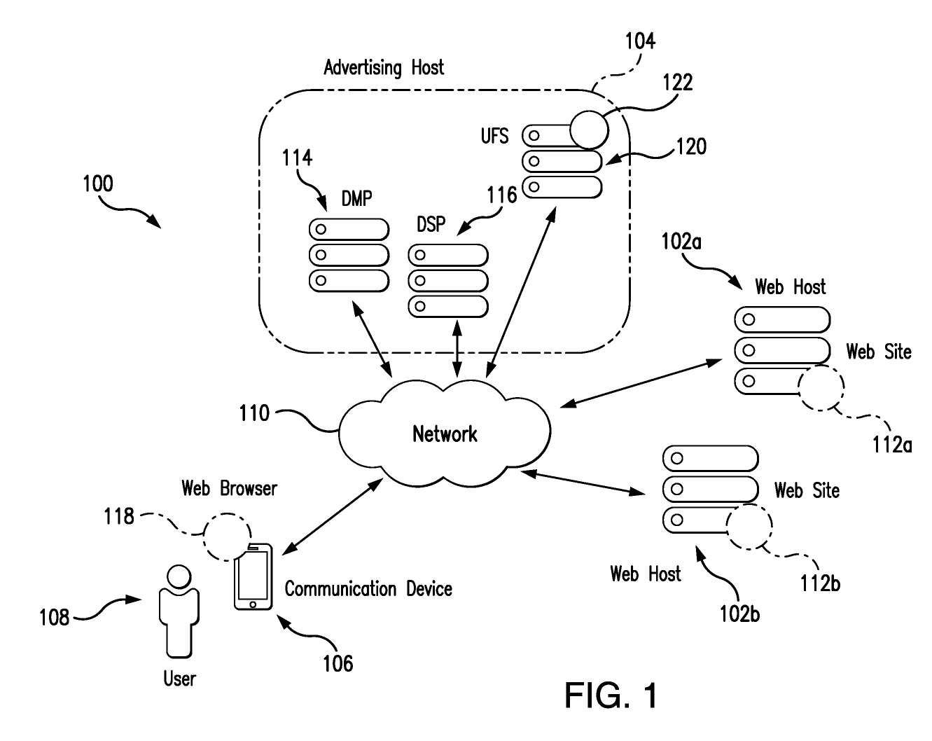

FIG. 1 illustrates an exemplary system 100, in which one or more aspects of the present disclosure may be implemented. Although the system 100 is presented in one arrangement, other embodiments may include the parts of the system 100 (or other parts) arranged otherwise depending on, for example, relationships among different users, web sites, web hosts, advertising host(s), DMP(s), and/or DSP(s) in the system 100, particular types of communication devices and/or browsers utilized in the system 100 to browse web sites, types of cookies generated and/or stored, types of data collected, privacy requirements, etc.

The illustrated system 100 generally includes two web hosts 102a-b, an advertising host 104, and a communication device 106 associated with a user 108. Each of the web hosts 102a-b, the advertising host 104, and the communication device 106 includes a computing device, and each is coupled to and/or in communication with a network 110. The network 110 may include one or more of, without limitation, a local area network (LAN), a wide area network (WAN) (e.g., the Internet, etc.), a mobile network, a virtual network, and/or another suitable public and/or private network capable of supporting communication among two or more of the parts illustrated in FIG. 1, or any combination thereof.

In general, the web hosts 102a-b are configured to provide web sites 112a-b, respectively, to users (including the user 108), whereby the users are permitted to view content related to one or more products (e.g., goods, services, etc.) (broadly, network objects). As such, the web sites 112a-b may be considered product web sites, etc. The web sites 112a-b are generally defined by multiple interfaces, which include the content related to the products and permit the user 108 to select the products and/or a link associated with the products (e.g., an advertisement related to the product, etc.). Further, in this example, the web hosts 102a and 102b are each associated with a different merchant, and each merchant offers particular products included in the content of the given interfaces for sale through the web sites 112a and 112b, respectively. In addition to the merchants, the web hosts 102a and/or 102b and/or the web sites 112a and/or 112b may be associated with one or more manufacturers of the product(s), which may not themselves offer the product(s) for sale through the web sites 112a and/or 112b, but which nevertheless benefit from the products to be purchased from one merchant or another.

The advertising host 104 of the system 100 is configured to direct advertising content to users, including, for example, the user 108, through one or more web sites, including the web sites 112a-b provided from the web hosts 102a-b. In the illustrated embodiment, the advertising host 104 includes a DMP 114 and a DSP 116, which may be separate or combined, in whole or in part, with each coupled to the network 110. The DMP 114 is configured to import data and analyze data imported therein. In particular, the DMP 114 is configured to import data, which is indicative of users, by unique ID, often associated with an IP address of a computing device of the user, and which includes demographic data about the user (e.g., age, gender, location, etc.) and/or metadata specific to the user (e.g., email, phone number, name, etc.). The DSP 116 is coupled to the DMP 114 and is configured to provide advertising purchasing opportunities for third parties based, at least in part, on the data included in the DMP 114.

The communication device 106 is associated with the user 108 and may include, without limitation, a smartphone, a laptop, a workstation, a tablet, etc. In the illustrated embodiment, the communication device 106 includes a web browser 118, which configures the communication device 106 to access web sites, including, for example, the web sites 112a-b hosted by the web hosts 102a-b, respectively.

In use, for example, the user 108 accesses the web site 112a, through the web browser 118, and selects a product (broadly, a network activity). In response to the selection, the web site 112a creates a cookie and stores the cookie to the web browser 118, whereby the cookie is provided to the web browser 118. The communication device 106, as configured by the web browser 118, then stores the cookie in memory. The cookie created by the web site 112a includes a unique ID associated with the communication device 106 and an identifier associated with the product selected by the user 108 (broadly, a network object identifier). It should be appreciated that the cookie, or a different cookie, may be created and/or stored for a product in response to a web search related to the product, or other indication, in the web browser 118, of the user's interest in the product, etc. It should also be appreciated that a cookie stored in the memory of the communication device 106 may be updated with a unique ID and/or identifier associated with the selected product, as desired (e.g., where a cookie was already created and provided to the web browser 118 when the user first accessed the web site 112a, etc.).

Apart from receiving and storing the cookie, the communication device 106, as configured by the web browser 118, optionally, reports the cookie to the advertising host 104. As an example, when the web site 112a includes advertising content from the advertising host 104, for example, the communication device 106, as configured by the web browser 118, provides the cookie data to the advertising host 104, whereby the cookie data is then stored, in this example, in the DMP 114. The cookie data may include the unique ID associated with the communication device 106 and/or the user 108, and additionally an identifier associated with the product (or other data associated with the web site 112a, the user 108, and/or the selected content). Alternatively or additionally, as another example, the communication device 106, as configured by the web browser 118, may provide the cookie data to the web host 102a, which may be configured to share the cookie data, including, specifically, the unique ID of the communication device 106 and the identifier of the product, with the DMP 114 and/or the advertising host 104 (whereby, when shared with the advertising host 104, the advertising host 104 may be configured to pass the cookie data to the DMP 114). The web host 102a may be configured to further share demographic data and/or specific metadata (e.g., an email address, a phone number, a name, etc.) related to the user 108 with the DMP 114 and/or the advertising host 104 (whereby, again, when shared with the advertising host 104, the advertising host 104 may be configured to pass the demographic data to the DMP 114), if known and/or as desired or permitted. It should be appreciated that the cookie and/or cookie datasets (and even demographic data and/or specific metadata) may be provided by the web host 102a and/or communication device 106 to the DMP 114 and/or advertising host 104 in various manners and/or at various times, for example, in accordance with specific vendor regulations and/or procedures. Regardless of the manner or timing by which the DMP 114 receives the cookie, cookie datasets, demographic data, and/or metadata, though, the DMP 114 is configured to build an audience of unique IDs and, as discussed in more detail below, to stitch together points of interest on potentially anonymous web users for the DSP 116 to consume (e.g., in response to a user of the DMP 114 purchasing a cookie dataset via the DMP 114 or at one more or more other times or intervals, etc.).

In response to the cookie data, the DMP 114 at the advertising host 104 is configured to include the cookie data, including the unique ID, in one or more analyses related to the selected product, as determined from the identifier of the product. The DMP 114, then, is configured to include the user 108 and/or communication device 106 (as represented by the unique ID for the user 108) in one or more categories and/or lists based on the analyses (e.g., a list or category of users that have indicated interest in the given product or type of product, etc.). The DMP 114 is configured to further make the one or more analyses, categorizations, and/or lists available to the DSP 116, which includes the user 108, as represented by the unique ID, as available for retargeting advertising for the product (or product(s) related thereto, etc.). In connection therewith, the web host 102a is configured to acquire advertising rights from the DSP 116, for example, through a bidding process. In response, the DSP 116 is configured to deliver advertising content for the selected product, or a similar type of product, offered for sale on the web site 112a, to one or more other web sites (e.g., web site 112b, etc.) accessed by the user 108, at the communication device 106, through the web browser 118.

It should be appreciated that the two web hosts 102a-b are included in the system 100 for ease of description, and that in other system embodiments various different web hosts, or merchants associated with the web hosts, may be included and vying for advertising time and/or space offered by the DSP 116. In addition, various other communication devices, associated with the same or different users, and a different number of advertising hosts, DMPs, and/or DSPs, may be included in other system embodiments.

With continued reference to FIG. 1, the advertising host 104 in the system 100 further includes a user feedback server or UFS 120, which is coupled to the network 110 and configured, by computer-executable instructions, to perform one or more of the operations described herein. The UFS 120 is a stand-alone server in FIG. 1, but may be included in whole, or in part, in the DMP 114 and/or the DSP 116, or otherwise, in the advertising host 104, or even apart from the advertising host 104.

In general, the UFS 120 is configured to provide (e.g., transmit, etc.) a UFS web site 122, which is accessible to the user 108, for example, via the web browser 118. Specifically, the UFS web site 122 includes a form for a feedback input, which is displayed at the communication device 106, by the web browser 118, and permits the user 108 to provide a feedback input to the UFS 120 by entering a product identification or other description of a product (broadly, a network object identifier), when the user 108 has purchased or otherwise lost interest in the product or type of product. In this manner, the UFS 120 is configured to provide the web site 122 soliciting a feedback input associated with a prior network activity of the user 108. Further, it should be appreciated that the product identification or description may be specific (e.g., the brand, model name, and/or model number the product, etc.) or general (e.g., an identification or description of the product as a “Hotel in Florida” or a “Mattress,” a “Television,” or a “Cell Phone;” etc.). In general, in this example, the feedback input serves as a designation or indicator that the user 108 has no degree of interest in the product or product type (e.g., based on a product or type of product previously selected by the user 108 at web site 112a, etc.).

When the user 108 provides the identification, the UFS 120 is configured to receive the product identification or description, as a feedback input, via the UFS web site 122, along with the unique ID associated with the communication device 106 and/or the user 108 (as provided by the web browser 118 based on the stored cookie) as the feedback input, whereby the unique ID may be received (directly or indirectly) from the stored cookie. In this manner, it should be appreciated that the UFS 120 may be configured to receive the unique ID from the user 108 (e.g., via the web browser 118, etc.) without the user 108 having to manually enter the unique ID into the UFS web site 122 or otherwise identify the unique ID, etc.

The UFS 120, in turn, is configured to provide (e.g., transmit, etc.) the feedback input (or at least a portion thereof), including the unique ID and the product identification or description, via an application programming interface (API), for example, to the DMP 114 and/or the DSP 116. Upon receipt of the feedback input, the DMP 114, for example, is configured to modify the analysis related to the product or type of product, for the unique ID, to remove or otherwise limit the appearance of the user 108 as a candidate for retargeting advertising for the product or type of product. It should be appreciated that, in one or more embodiments, the API may be included at the UFS 120, whereby the DMP 114 and/or DSP 116 may call the API to request feedback input from the UFS 120 via the API (e.g., at one or more predetermined intervals, etc.), or the API may be include at the DMP 114 and/or DSP 116, whereby the UFS 120 may call the API to pass feedback input to the DMP 114 and/or DSP 116 (e.g., in response to receiving feedback input from a user or at one or more predetermined intervals, etc.). Regardless, the DMP 114, then, is configured to adjust the inclusion of the user 108 and/or communication device 106 (as represented by the unique ID for the user 108) in one or more categories and/or lists, based on the feedback input, whereby the user 108 (as represented by the unique ID) may be removed from the one or more categories and/or lists.

With that said, it should be appreciated that where the feedback input includes a product identification or description specific to a product (e.g., the brand, model name, and/or model number the product (e.g., Samsung 48″ Flat Panel TV 1080p 120 Hz Smart TV—Black—UN48J6200AFXZA, etc.) etc.), the DMP 114 may be configured to remove the user 108 as a candidate for retargeting advertising only for that specific product. Additionally, or alternatively, the DMP 114 may be configured to remove the user 108 as a candidate for retargeting advertising for products of the same general type (e.g., all Televisions, etc.). Where the feedback input includes a product identification or description that only indicates a general type of product (e.g., “Television,” etc.), the DMP 114 may be configured to remove the user 108 as a candidate for targeting advertising for products of the same general type (e.g., all Televisions, etc.).

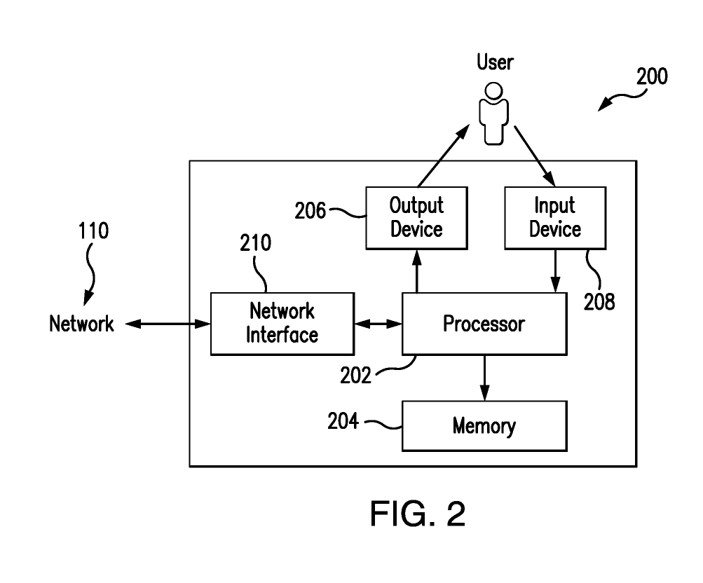

FIG. 2 illustrates an exemplary computing device 200 that can be used in the system 100 of FIG. 1. The computing device 200 may include, for example, one or more servers, workstations, personal computers, laptops, tablets, smartphones, etc. In addition, the computing device 200 may include a single computing device, or it may include multiple computing devices located in close proximity or distributed over a geographic region, so long as the computing devices are specifically configured to function as described herein. In the exemplary embodiment of FIG. 1, each of the web hosts 102a-b, the advertising host 104, and the communication device 106, as well as the DMP 114, the DSP 116, and the UFS 120, is and/or includes a communication device which includes and/or is generally consistent with the computing device 200. However, the system 100 should not be considered to be limited to the computing device 200, as described below, as different computing devices and/or arrangements of computing devices may be used in other embodiments. In addition, different components and/or arrangements of components may be used in other computing devices.

Referring to FIG. 2, the exemplary computing device 200 includes a processor 202 and a memory 204 coupled to (and in communication with) the processor 202. The processor 202 may include one or more processing units (e.g., in a multi-core configuration, etc.). For example, the processor 202 may include, without limitation, a central processing unit (CPU), a microcontroller, a reduced instruction set computer (RISC) processor, an application specific integrated circuit (ASIC), a programmable logic device (PLD), a gate array, and/or any other circuit or processor capable of the functions described herein.

The memory 204, as described herein, is one or more devices that permit data, instructions, etc., to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 204 may be configured to store, without limitation, unique IDs, identifiers of products, cookies, feedback input, data relating to consumers, and/or other types of data (and/or data structures) suitable for use as described herein. Furthermore, in various embodiments, computer-executable instructions may be stored in the memory 204 for execution by the processor 202 to cause the processor 202 to perform one or more of the functions described herein, such that the memory 204 is a physical, tangible, and non-transitory computer readable storage media. Such instructions often improve the efficiencies and/or performance of the processor 202 and/or other computer system components configured to perform one or more of the various operations herein. It should be appreciated that the memory 204 may include a variety of different memories, each implemented in one or more of the functions or processes described herein.

In the exemplary embodiment, the computing device 200 also includes an output device 206 that is coupled to (and is in communication with) the processor 202 (however, it should be appreciated that the computing device 200 could include one or more additional output devices other than the output device 206, etc.). The output device 206 outputs information (e.g., advertisements, product details, etc.), visually or audibly, for example, to a user of the computing device 200, etc. And, various interfaces (e.g., as defined by the web sites 112a-b and 122, etc.) may be displayed at computing device 200, and in particular at the output device 206, to display certain information in connection therewith. The output device 206 may include, without limitation, presentation units such as a liquid crystal display (LCD), a light-emitting diode (LED) display, an organic LED (OLED) display, an “electronic ink” display, speakers, etc.; another computing device; etc. In some embodiments, the output device 206 may include multiple devices.

In addition, the computing device 200 includes an input device 208 that receives inputs from the user (i.e., user inputs) of the computing device 200 such as, for example, inputs selecting products, as further described below; etc. The input device 208 may include a single input device or multiple input devices. The input device 208 is coupled to (and is in communication with) the processor 202 and may include, for example, one or more of a keyboard, a pointing device, a mouse, and/or a touch sensitive panel (e.g., a touch pad or a touch screen, etc.), another computing device, and/or an audio input device. In various exemplary embodiments, a touch screen, such as that included in a tablet, a smartphone, or similar device, may behave as both the output device 206 and an input device 208.

Further, the illustrated computing device 200 also includes a network interface 210 coupled to (and in communication with) the processor 202 and the memory 204. The network interface 210 may include, without limitation, a wired network adapter, a wireless network adapter, a mobile network adapter, or other device capable of communicating to one or more different ones of the networks herein, including network 110, and/or with other devices described herein. In some exemplary embodiments, the computing device 200 may include the processor 202 and one or more network interfaces incorporated into or with the processor 202.

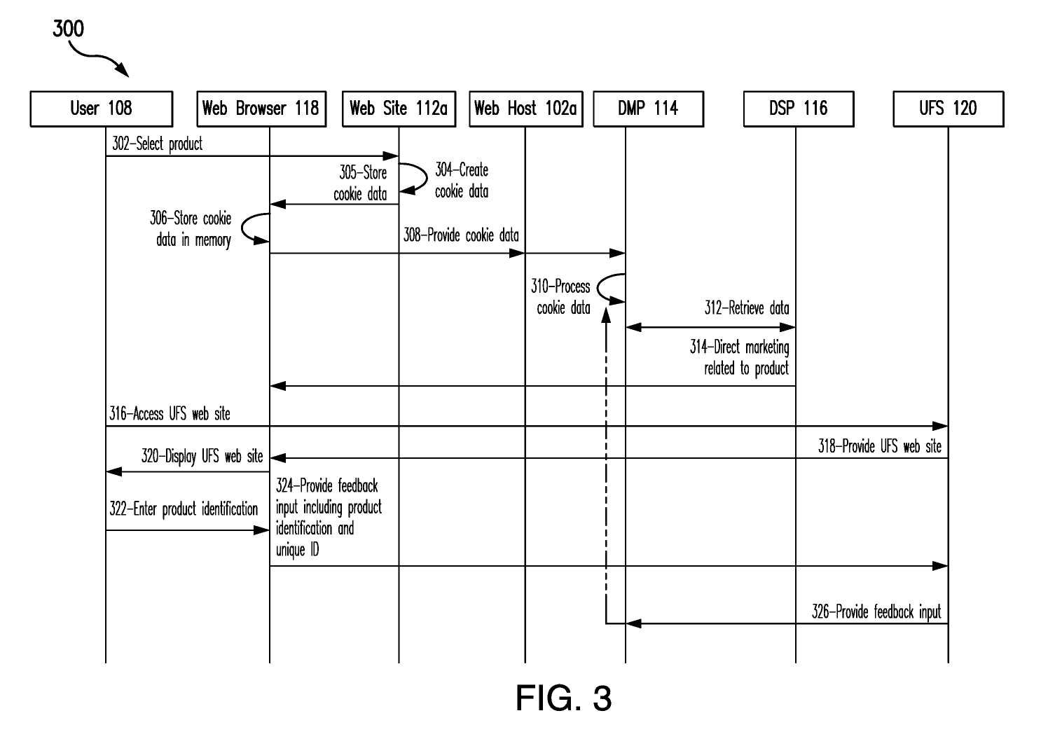

FIG. 3 illustrates an exemplary method 300 for use in controlling network activity associated with a web browser. The exemplary method 300 is described as implemented in the UFS 120 and the other parts of the system 100. Reference is also made to the computing device 200. However, the methods herein should not be understood to be limited to the system 100 or the computing device 200, as the methods may be implemented in other systems and/or computing devices. Likewise, the systems and the computing devices herein should not be understood to be limited to the exemplary method 300.

In method 300, the user 108 is described as being between the ages of 35 and 40 years old, as being female, and as being single. With that said, the user 108 initially selects, at 302, a product within the web site 112a provided by the web host 102a and displayed by the web browser 118 at the communication device 106 (where the product is associated with a merchant desiring to sell the product). In response, the web browser 118 displays content related to the product, as defined by the web site 112a, at the communication device 106 (e.g., a product image, a product description, an option to purchase the product, etc.) (e.g., at output device 206 of the communication device 106, etc.).

In addition, the web site 112a (as being displayed via the web browser 118 to the user 108) creates, at 304, a cookie for the user 108 and the selected product, which includes the unique ID for the user 108 and the identifier of the product. In connection therewith, the unique ID may include an IP address of the communication device 106, an electronic identification number (EID) associated with the communication device 106 (e.g., a MAC address, etc.), or other suitable unique ID, etc. It should be appreciated, however, that the unique ID may or may not be based on an attribute of the communication device 106. And, the identifier of the product may include, without limitation, an identification or value that is general with respect to the selected product (e.g., “Television” where the user 108 selected a Samsung 48″ Flat Panel TV 1080p 120 Hz Smart TV—Black—UN48J6200AFXZA or “Hotel” or “Florida Hotel” where the user selected a specific hotel in Florida, etc.) or an identification or value that is specific to the product (e.g., a hashed identifier that may be mapped at a later time to a specific selected Samsung 48″ Flat Panel TV 1080p 120 Hz Smart TV—Black—UN48J6200AFXZA or a specific selected hotel in Florida, etc.), etc. However, general identifications or values may, in one or more embodiments, allow for simpler processing of the cookie (or cookie data) for provision to the DMP 114 (e.g., as part of a cookie dataset, etc.) or even at the DMP 114. It should also be appreciated that the identifier of the product may be associated with and/or tagged with an indication in the cookie such as, for example “ProductID=,” whereby the cookie (and/or cookie data) may be easily read or parsed for the identifier of the product and/or to allow for simple processing of the cookie (and/or cookie data). The web site 112a then stores the cookie (and/or cookie data) to the web browser 118, at 305 (whereby the cookie (and/or cookie data) is provided to the web browser 118), and the communication device 106, as configured by the web browser 118, stores, at 306, the cookie (and/or cookie data) in memory (e.g., memory 204, etc.) associated with the web browser 118 in the communication device 106.

The cookie data, including the unique ID and identifier for the product, is next provided, at 308, to the web host 102a and then to the DMP 114 at the advertising host 104, where the cookie data is stored in the DMP 114. In connection therewith, when the cookie data is received by the web host 102a, it may be provided to the DMP 114 directly, or via the advertising host 104, directly or indirectly, etc. It should be appreciated that the cookie data may be provided to the DMP 114 (and the advertising host 104) in various different manners under various different conditions and/or restrictions. For example, in one embodiment, the web browser 118 may provide the cookie data directly to the DMP 114.

Once the cookie data is received (or at some time thereafter), the DMP 114 processes, at 310, the cookie data, in combination with cookie data from additional other users. The processing may include categorizing the cookie data into one or more different categories, along with the cookie data for the additional other users. For example, when the product previously selected by the user 108 (at 302) includes a hotel in Florida (as indicated by the cookie data for user 108), the user 108 may be added to a list of users that have selected a hotel in Florida, who are between the ages of 35 and 40 years old, female and single, consistent with the user's demographic. It should be appreciated that the list, in this example, may be limited to users that have selected a particular hotel in Florida (i.e., where each user in the list has selected the same hotel or a hotel in the same location) or may be limited to users that have in general selected a hotel in Florida (i.e., where each user in the list has selected a hotel in Florida, but not necessarily the same hotel) or even to users who have selected a hotel in general. In addition, it should be appreciated that in other examples, the list may not be based on demographic data at all.

With that said, the user 108 and/or the communication device 106 may be classified and/or categorized as part of the above processing into any suitable categories, classes, etc., as necessary or desired, based on the information known about the user 108, included with the cookie data, etc. For example, the user 108 and/or communication device 106 may be classified and/or categorized based, at least in part, on the web browser 118 used to select the given product, on the web host 102a and/or web site 112a, specific to the web browser 118, at which they selected the product, etc. (e.g., where a list only includes users that have selected a product at web site 112a, etc.). In general, the DMP 114 does not collect merchant data from the user 108 in connection with classifying and/or categorizing the user 108 (or in order to do so). Instead, for example, the DMP 114 may be leveraged to identify unmarketable people from a list for campaigns (such that a marketer may not need to know where a user bought a product, but may simply want to remove anyone who says they've recently bought the product).

With continued reference to FIG. 3, once the cookie data for the user 108 is processed, along with cookie data for other users, the DSP 116 interacts with the DMP 114 to retrieve the cookie data (at least in part), at 312, from the DMP 114. In turn, the DSP 116 then offers to display advertising content to users within the particular category (e.g., based on communication between the DMP 114 and the DSP 116, etc.), in view of the retrieved cookie data. The cookie data retrieved by the DSP 116 may include, for example, the unique ID for the user 108 and unique IDs for other users for action by the DSP 116, whereby the users associated with the unique IDs may be targeted with advertising based on their unique IDs being associated with a particular category (e.g., a category for a given product or type of product previously selected, etc.). As such, the DSP 116 may not need know personal identifying information for users in order to target the users with advertising. A web host or associated merchant (e.g., web host 102a or a respective merchant associated therewith, etc.) may then bid on and, if successful, purchase advertising for one or more users that have previously selected a given product (e.g., a hotel in Florida in the above example, etc.) at the web site associated with the web host and/or merchant (e.g., web site 112a) and that are between the ages of 35 and 40, female and single, i.e., a category in which the user 108 belongs. In this example, the particular category is limited to users that have selected a particular hotel in Florida at web site 112a. Upon the purchase, the DSP 116 directs, at 314, advertising related to the previously selected product for sale (e.g., the particular selected hotel in Florida or another hotel in Florida, etc.) to the web browser 118 at one or more web sites associated with the advertising host 104, whether it be one or both of the web sites 112a-b or otherwise. In this manner, the user 108 will see this advertising when accessing the one or more web sites, for example, after the user 108 leaves web site 112a (e.g., where the user 108 initially selected a hotel in Florida), and accesses web site 112b.

If the user 108 selects the advertising, the web browser 118 would be directed to the web site associated with the web host and/or merchant who purchased the advertising (e.g., to web site 112a in this example where the web host 102a and/or the merchant associated therewith purchased the advertising (e.g., to a specific web page for the product reflected in the directed advertising, etc.), etc.). This is referred to, generally, as retargeted advertising to the user 108, based on the prior selection(s) and/or indication(s) of interest in the product by the user 108. The advertising may be provided to any number of different web sites that bargain with the advertising host 104 (and are then displayed at the web browser 118). In this manner, the user 108 would be subject to the retargeted advertising as he/she browses from web site to web site on the Internet (e.g., as he/she browses on web site 112b via the web browser 118, etc.).

Separately in the method 300, when the user 108 purchases the product or a similar product (e.g., from the web host 102a, for example, or any other merchant, etc.), the user 108 generally loses interest in further purchasing the product and, potentially, the same type of products or other products in same category. Other reasons may also exist for losing interest in a product, such as, for example, finding an alternate product, deciding not to purchase the product, etc. Thereafter, the user 108 may desire to not receive marketing related to the product (e.g., marketing for the same product or type of product, etc.) when browsing web sites at the web browser 118 (e.g., web sites 112a-b or other web sites, etc.). Similarly, generally, web hosts (or other merchants) (e.g., web hosts 102a-b, etc.) will not want to spend advertising resources on a user that has already purchased the product, another similar product, or otherwise lost interest in the product.

In connection therewith, the user 108 accesses, at 316, the UFS 120 in order to access the UFS web site 122 to provide a feedback input with respect to the product. When the UFS 120 is accessed, the UFS 120 provides (e.g., transmits, etc.), at 318, the UFS web site 122 to the web browser 118, whereupon it is displayed to the user 108, at 320. The UFS web site 122 includes, for example, an interface form having a fillable field to include a product identification for the product, or other description of the product, that the user 108 is no longer interested in. Again, it should be appreciated that the product identification or description may be specific to the product (e.g., the brand, the model name, and/or the product number of the product, etc.) or it may be general to the product (e.g., an identification or description of the product as a “Hotel in Florida” or a “Mattress,” a “Television,” or a “Cell Phone;” etc.). Regardless, the product identification generally includes a discernable or readable description of the product. Through the interface form, then, the user 108 enters the product identification for the product, at 322, and, optionally, may also provide additional information, such as, for example, personal identifying information for the user 108 (e.g., an email address, a phone number, first and/or last name, etc.) to facilitate matching of the request to the cookie data which underlies the marketing being provided to the user 108.

When the data is provided, the web browser 118 provides, at 324, the product identification and the unique ID associated with the communication device 106, along with any optional personal identifying information, back to the UFS 120. It should be appreciated that where the cookie includes personal identifying information of the user 108, the personal identifying information therein (or portion thereof) may, or may not, be provided, in one or more embodiments, by the web browser 118 to the UFS 120, without the user manually entering the personal identifying information through the interface form of the UFS web site 122. It should also be appreciated that personal identifying information received by the UFS 120 may be encrypted (e.g., as part of an encrypted, secure cookie (and/or cookie data) that may be leveraged by the DMP 114, etc.). It should also be appreciated that where personal identifying information is received by the UFS 120 in unencrypted form (e.g., via the interface form of the UFS web site 122, etc.), the UFS 120 may itself encrypt the personal identifying information.

With further reference to FIG. 3, the UFS 120, in turn, provides (e.g., transmits, etc.), at 326, the feedback input, or part thereof (by the unique ID and/or email address for the user 108, etc.), to the DMP 114 of the advertising host 104. In response, the DMP 114 returns, as designated by the dotted line in FIG. 3, to processing the cookie data, at 310, along with the other cookie data, where the unique ID, email address and product identification is associated with a feedback input indicative of no interest for the user 108. By including the email address (or other particular information for the user 108), the feedback input may be particularly linked, stitched and/or identified to all communication devices associated with the user's email address. This may be useful when the user 108 employs multiple different communication devices associated with the account (e.g., a smartphone, a laptop and a desktop, etc.). Conversely, the user 108 may submit a feedback input from each of the communication devices at which he/she selected and/or searched for the product. As a result of the processing and the feedback input, the DMP 114 will remove the user 108 and/or the communication device(s) associated with the user 108 from the categories associated with interest in the product, whereby the inclusion of the user 108 in one or more categories is adjusted.

Then, going forward, the advertising to the user 108 will exclude the product and/or type of product indicated in the feedback input, but may include other products targeted or retargeted to the user 108, as a result of further searching and/or selecting of products.

In view of the above, the systems and methods herein permit network activities, such as browsing for and/or selecting products, to be corrected and/or controlled, by further input of users to reflect an actual interest of the users in the products. More generally, prior Internet ad serving technology is configured, at least in part, to retarget advertising based on the widely (and routinely and conventionally) accepted premise in Internet ad serving that a user who views and/or selects a product is interested in purchasing the product. This perception causes advertising to be directed to the user for the product or the type of product. When the user loses interest based on a purchase of the product or otherwise (or never actually had interest), there is no feedback available from the user to the advertising host to inform the advertising host that the perception is no longer valid. The systems and methods herein provide a feedback mechanism to the user via the UFS (as discussed in detail above), whereby the user is able to correct and/or update the perception of interest by indicating a lack of interest to the UFS. This correction and/or update is then provided to the advertising host, which, in turn, modifies its analysis of the user to remove, if proper, the user from the retargeting advertising for products for which the user has lost interest.

The systems and methods herein therefore may enhance Internet ad serving technology and override the routine and conventional sequence of events originally triggered in the context of Internet ad retargeting technology, whereby advertising efficiencies are provided to the user, in that the enhanced Internet ad serving technology may serve advertising to the user that is more relevant to products the user actually has interest in purchasing. The systems and methods herein also enhance the Internet as a whole, whereby the user will have a better experience as a result of the more relevant advertising. What's more, the systems and methods herein enhance Internet ad serving technology, whereby efficiencies are provided to the web host (or merchants) who purchase retargeting advertising to be served, in that the web hosts are less likely to pay for advertising to users that have lost interest in the product, or never had interest in the first place. That is, the feedback input reduces the audience for the web servers to those that are interested, or likely interested.

The problem of users being served with targeted advertising for products in which they have no interest (e.g., where they have already purchased the product, etc.) specifically arises in the realm of computer networks and, in particular the Internet, where users browse for products via a web site provided by a web host and where an advertising host, DMP, and/or DSP is/are employed for retargeting advertising. The systems and methods herein provide for a UFS located on a network to solve this problem, whereby the routine and conventional operation of the DMP and/or DPS is manipulated to remove the users, when appropriate, from the retargeting advertising.

Again and as previously described, it should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the following operations: (a) transmitting, by a user feedback server (UFS), a web site to a user at a communication device, the web site soliciting a feedback input associated with a prior network activity of the user; (b) receiving, at the UFS, the feedback input for a network object, from a user, via the web site, the feedback input including a unique identifier (ID) and a network object identifier associated with the network object of the prior network activity, the unique ID associated with at least one of the user and the communication device; and (c) transmitting, by the UFS, at least a portion of the feedback input to a host, whereby the host is permitted, based on the unique ID and the network object identifier, to adjust inclusion of the user and/or the communication device in one or more categories of users and/or communication devices.

Exemplary embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for use in controlling categories of users and/or communication devices based on network activity associated with the users at web browsers, the method comprising:
transmitting, by a user feedback server (UFS), a web site to a user at a communication device, the web site soliciting a feedback input associated with a prior network activity of the user;
receiving, at the UFS, the feedback input for a network object, from the user, via the web site, the feedback input including a unique identifier (ID) and a network object identifier associated with the network object of the prior network activity, the unique ID associated with at least one of the user and the communication device; and
transmitting, by the UFS, at least a portion of the feedback input to a host, whereby the host is permitted, based on the unique ID and the network object identifier, to adjust inclusion of the user and/or the communication device in one or more categories of users and/or communication devices.

2. The computer-implemented method of claim 1, wherein the network object includes a product;
wherein the prior network activity includes a selection of the product; and
wherein the host includes an advertising host, such that the one or more categories of users and/or communication devices serves as a basis for retargeting advertising to the user.

3. The computer-implemented method of claim 2, wherein the feedback input includes an indicator associated with a degree of interest of the user in the product.

4. The computer-implemented method of claim 2, wherein the network object identifier includes at least one specific identification of the product selected from the group consisting of: a brand of the product, a model name of the product, and a model number the product.

5. The computer-implemented method of claim 2, wherein receiving the feedback input from the user includes receiving the unique ID included in a cookie created by a product web site associated with the selection of the product and stored in a web browser included in the communication device.

6. The computer-implemented method of claim 5, wherein receiving the feedback input from the user further includes receiving personal identifying information of the user included in the cookie.

7. The computer-implemented method of claim 6, wherein the personal identifying information is encrypted.

8. The computer-implemented method of claim 2, wherein the advertising host includes a Data Management Platform (DMP); and
wherein providing the feedback input to the advertising host comprises providing the feedback input to the advertising host for the DMP to adjust inclusion of the user and/or the communication device in one or more categories of users and/or communication devices.

9. A system for use in controlling categories of users associated with advertising, based on network activity associated with the users at web browsers, the system comprising:
a user feedback server (UFS) having a processor configured, by executable instructions stored in non-transitory computer-readable media, to:
provide a web site accessible to a user at a communication device, the web site soliciting a feedback input associated with a prior selection of a product by the user at a product web site;
receive the feedback input for the product, from the user, via the web site, the feedback input including a unique identifier (ID) and a product identifier associated with said product, the unique ID associated with at least one of the user and the communication device; and
provide the feedback input to an advertising host, whereby the advertising host is permitted, based on the unique ID and the product identifier, to exclude the user and/or the communication device from one or more categories of users and/or communication devices to which advertising is to be directed by the advertising host.

10. The system of claim 9, wherein the feedback input includes an indicator associated with a degree of interest of the user in the product.

11. The system of claim 9, wherein the product identifier includes a brand of the product, a model name of the product, and/or a model number the product.

12. The system of claim 9, wherein the processor is configured, by the executable instructions, in connection with receiving the feedback input from the user, to receive the unique ID via a cookie created by the product web site associated with the prior selection of the product.

13. The system of claim 12, wherein the processor is configured, by the executable instructions, in connection with receiving the feedback input from the user, to receive personal identifying information of the user included in the cookie.

14. The system of claim 13, wherein the personal identifying information is encrypted.

15. The system of claim 13, wherein the processor is configured, by the executable instructions, in connection with receiving the personal identifying information of the user, to receive an email address of the user; and
wherein the processor is configured, by the executable instructions, in connection with providing the feedback input to the advertising host, to provide the email address of the user to the advertising host, whereby the advertising host is permitted to link a plurality of communication devices associated with the user to the email address of the user.

16. The system of claim 9, wherein the advertising host includes a Data Management Platform (DMP); and
wherein the processor is further configured, by the executable instructions, to provide the feedback input to the advertising host for the DMP to exclude the user and/or the communication device from the one or more categories of users and/or communication devices to which advertising is to be directed by the advertising host.
